(19) United States
(12) Patent Application Publication
(10) Pub. No.: US 2005/0158113 A1
(43) Pub. Date: Jul. 21, 2005

(54) Erasable writing system

(76) Inventor: Stephen D. Wehmeyer, Cincinnati, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/828,073

(22) Filed: Apr. 20, 2004

Related U.S. Application Data
(60) Provisional application No. 60/537,648, filed on Jan. 20, 2004.

(51) Int. Cl. B05C 1/00; A47L 13/12

(52) U.S. Cl. 401/23; 401/17

(57) ABSTRACT

A system including a writing instrument including a body having a marking portion and an eraser portion, wherein the marking portion is configured to dispense a permanent ink and the eraser portion is configured to dispense a solvent which solubilizes the permanent ink.

This application claims priority to U.S. Provisional App. Ser. No. 60/537,648 filed Jan. 20, 2004, the contents of which are hereby incorporated by reference.

The present invention is directed to an erasable writing system and, more particularly, to an erasable writing system having a marker with a marker portion and an eraser portion for erasing markings made by the marker portion.

### BACKGROUND

Permanent markers are typically used in home, classroom or office environments for various marking purposes. Permanent markers allow a user to mark indicia on various substrates, including polymer and plastic based substrates, without the risk of the markings being smudged or accidentally erased. Permanent markers can also be used to mark on various items which cannot be written upon by other writing instruments. For example, plastic and polymer based substrates typically are not capable of being marked upon with nonpermanent inks.

Permanent markers may be advantageous in that the risk of smudging the markings is minimized once the ink has dried, thereby minimizing the risk of transference of ink to items and persons that come into contact with the markings. However, a disadvantage of permanent markers is that the markings cannot easily be erased.

Dry erase markers and the like are often used to provide an erasable marking system. Dry erase markers and the like are not permanent and their markings can easily be removed from a polymeric substrate by the application of frictional forces (i.e. by a hand or by an eraser). However, the easily erasable markings of dry erase markers can accidentally be erased and/or the markings can easily rub off on items or persons coming into contact with the markings.

Accordingly, there is a need for an erasable writing system for marking on a substrate, such as a polymer or plastic based substrate, without smudging, wherein the marking can be erased. There is also a need for a writing instrument which can write with permanent ink and which can also erase permanent ink.

### SUMMARY

The present invention is an apparatus and system for marking and erasing permanent ink from a substrate. In one embodiment, the invention is a system including a writing instrument including a body having a marking portion and an eraser portion, wherein the marking portion is configured to dispense a permanent ink and the eraser portion is configured to dispense a solvent which solubilizes the permanent ink.

In another embodiment the invention is a method for marking and erasing ink including the steps of providing a writing surface and providing a writing instrument having a body including a marking portion and an eraser portion. The marking portion includes a permanent ink capable of marking on the writing surface and the eraser portion includes a solvent capable of solubilizing the permanent ink. The method further includes the steps of applying the marking portion to the writing surface such that the permanent ink is deposited on the writing surface, and applying the erasing portion to the deposited permanent ink such that the solvent is deposited on and solubilizes the deposited permanent ink.

Other objects and advantages of the present invention will be apparent from the following description, the accompanying drawings and the appended claims.

### BRIEF DESCRIPTION OF THE DRAWINGS

The invention can be understood with reference to the following drawings. In the drawings, like reference numerals designate corresponding parts throughout the several views. Also, the components in the drawings are not necessarily to scale.

FIG. 1 is a front elevational view of the marker of the present invention with a portion of the marker body being cut out;

FIG. 2 is a front elevational view of the marker of FIG. 1 and including a cap mounted thereon;

FIG. 3 is a front elevational view of a writing surface being marked upon by the marker of FIG. 1; and

FIG. 4 is a front perspective view of a binder including a writing surface and being marked upon by the marker of FIG. 1.

### DETAILED DESCRIPTION

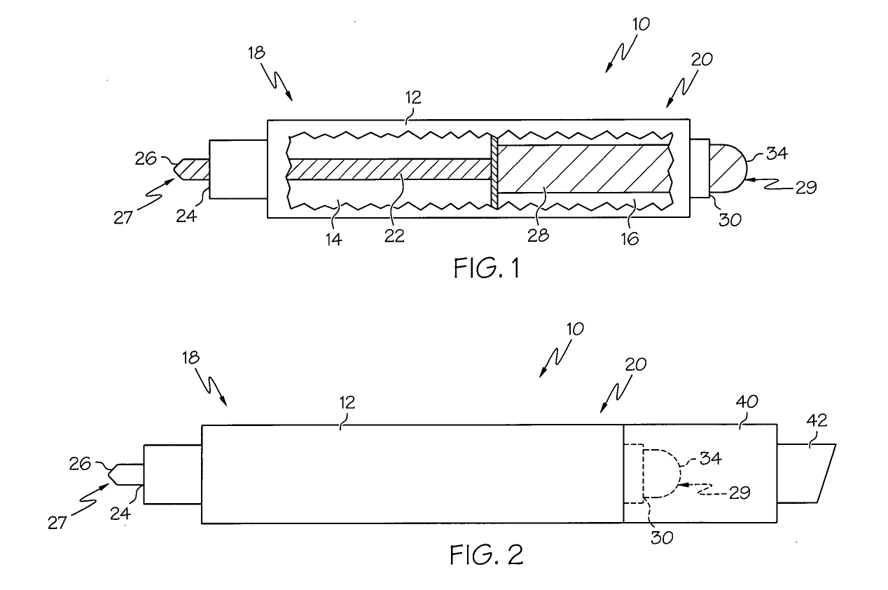

With reference to FIG. 1, the marker or writing instrument 10 of the present invention includes a writing instrument body or marker body 12. The marker body 12 may be generally tubular or cylindrical and may have a first portion 18 and a second portion 20. The marker body 12 may include a first reservoir 14 located generally inside of the first portion 18 and a second reservoir 16 located generally inside of the second portion 20, with the first 14 and second 16 reservoirs separated by a divider 15. The maker body 12 may include a first opening 24 that is located at an end of the marker body 12 adjacent to the first portion 18 and in communication with the first reservoir 14. The marker body 12 may also include a second opening 30 that is located at the other of the marker body 12 adjacent to the second portion 20 and in communication with the second reservoir 16.

The marker body 12 includes a first wick 22 generally closely received in the first opening 24 and extending into the first reservoir 14. The first wick 22 has an exposed portion 27 extending out of the first reservoir 14, with the exposed portion 27 having a writing tip 26. The marker body 12 includes a second wick 28 generally closely received in the second opening 30 and extending into the second reservoir 16. The second wick 28 has an exposed portion 29 extending out of the second reservoir 16, with the exposed portion 29 including a tip 34. The wicks 22, 28 may be made from a wide variety of materials, such as felt. Although the marker 10 is illustrated as having a tip 26, 34 at each end, the marker 10 may have a wide variety of other configurations for the tips 26, 34 and/or wicks 22, 28, including having the tips 26, 34, being oriented at various angles, being located in a side-by-side configuration, etc.

The first reservoir 14 may be filled with a permanent or indelible ink solution of any of a wide variety of colors. The permanent ink or permanent ink solution in the first reservoir 14 may be nearly any type of permanent ink or ink solution, such as a traditional organic solvent based permanent ink with a wide variety of pigments, dye, colorants or the like, or an aqueous type permanent ink as described in U.S. Pat. No. 5,131,776, the contents of which are incorporated by reference. The permanent ink may be an alcohol based (i.e. n-propyl alcohol) or other organic solvent based permanent ink. The permanent ink may be capable of marking on porous surfaces (e.g., paper, wood and the like) and nonporous surfaces (e.g., glass, metal, plastic and other polymer based surfaces). Further, the permanent ink may be resistent to smearing and re-wetting after application and may resist emulsification, dissolving or removal with soap and water.

The second reservoir 16 may be filled with a solvent that can dissolve the permanent ink or ink solution in the first reservoir 14. The solvent in the second reservoir 16 may be any solvent that is capable of solubilizing or dissolving permanent ink or a permanent ink solution that has been applied to a surface and allowed to dry. The solvent may be or include an ethyl alcohol, an n-propyl alcohol, or other organic based solvents.

For example, the solvent may be a dry-erase solution typically used in a dry-erase marker. Thus the solvent may also optionally include a colorant, dye or pigment and a binder resin such that the second portion 20 can operate as a dry-erase marker. In this case, when the dry-erase solution is applied to a polymeric or plastic type surface, the solvent evaporates and the binder resin and colorant remain behind as a friable discontinuous film.

The permanent ink solution in the first reservoir 14 may be soaked through the first wick 22, or permanent ink dispensing wick 22, and wicked through the permanent ink dispensing wick 22 until the permanent ink solution reaches the writing tip 26. In this manner, when the writing tip 26 contacts a substrate to be written upon, ink from the first reservoir 14 is deposited on the substrate. Similarly, the solvent in the second reservoir 16 soaks the second wick 28, or solvent dispensing wick 28, such that the solvent is wicked through the solvent dispensing wick 28 until it reaches the erasing tip 34. When the erasing tip 34 contacts the substrate, solvent from the second reservoir 16 is deposited onto the substrate and solubilizes (or dissolves) any ink deposited by the permanent ink dispending wick contacted by the solvent. Thus the marker 10 may be a double-ended felt-tip marker, although the marker 10 may include various other manners of dispensing the permanent ink and solvent, such as ball-point dispensers, gel-type dispensers, etc.

In another embodiment of the present invention, the marker 10 includes a cap 40 for covering either the erasing tip 34 (as shown in FIG. 2) or, alternatively or in addition, the writing tip 26. The cap 40 prevent the ink and solvent from evaporating through the wicks 22, 28 when the marker 10 is not in use. For example, as shown in FIG. 2, the cap 40 may include a body portion shaped to form a tight interference fit or seal with the marker body 12 to seal off the associated tip 26, 34. The cap 40 may also include an absorbent portion 42 located, for example, on an outer surface, or outer end surface, of the cap 40. The absorbent portion 42 may be made of a felt, cotton, foam, sponge-type material or other absorbent type material. The absorbent portion 42 may be used to wipe away markings that are deposited by the writing tip 26 and erased/dissolved by the erasing tip 34. The marker 10 may include two caps 40, with each cap 40 located on each end of the marker 10, and at least one cap 40 may include an absorbent portion 42, although both caps 40 may include an absorbent portion 42.

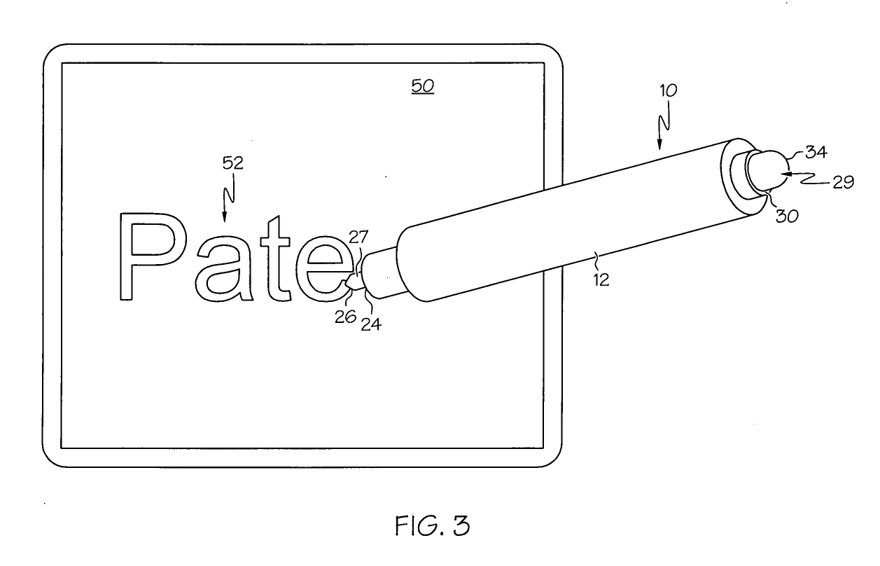

As shown in FIG. 3, a user may mark various markings 52 on a writing surface 50 using the writing tip 26 of the marker 10. The markings 52 may then be allowed to dry. Once dry, the markings 52 cannot be erased by simply rubbing the markings by hand, or with soap and water or the like. The permanent markings 52 may then be allowed to remain in place for as long as desired. Once it is desired to erase the markings 52, the erasing tip 34 is applied to the markings 52 to solubilize/erase/dissolve the markings 52. The erasing tip 34 may be moved over the markings 52 such that the solvent contacts the deposited markings 52 and solubilizes the markings 52, thereby allowing the markings 52 to be erased. A user may then take the cap 40 and apply the absorbent portion 42 to the writing surface 50 to wipe away or absorb the solubilized markings.

The writing surface 50 may be made of a typical plastic material such as polypropylene, polyethylene or the like that is capable of being marked upon using permanent ink, but not with typical water based inks. The writing surface 50 may have a glossy finish surface and/or a UV aqueous coating and/or other coatings. Further, the writing surface 50 may have a surface roughness sufficient to absorb or receive ink in the creases and recesses, but not exceedingly rough to make it overly difficult to remove the ink. In one embodiment, the writing surface 50 has an average surface roughness of between about 9-100 microns, or between about 50-1000 microns. The writing surface 50, permanent ink and solvent should be selected such that application of the permanent ink or solvent to the writing surface 50 does not significantly alter, destroy or marr the writing surface 50. Proper selection may allow the writing surface 50 to be used many times over for marking and erasing.

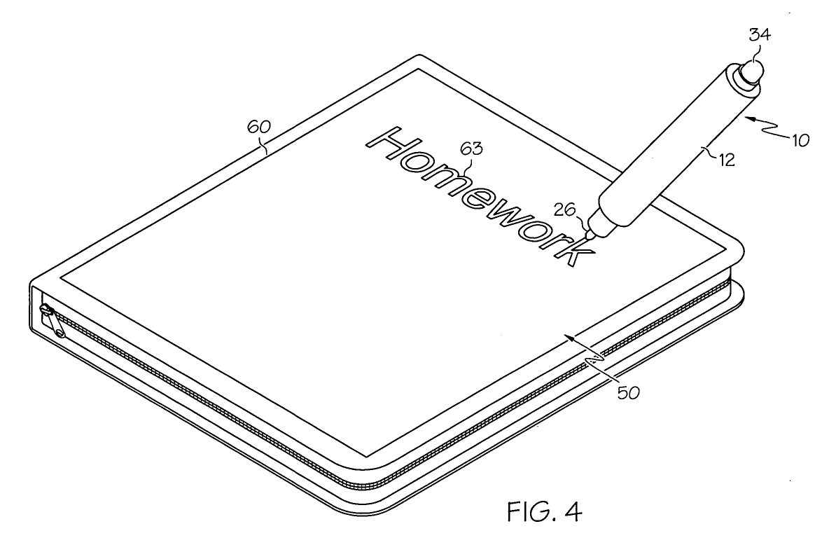

The writing surface 50 may be, include, or be part of various devices or products. For example, the writing surface 50 may be formed as part of a binder 60, notebook, folder, divider, portfolio, book cover or the like for school or business use (see FIG. 4). Thus, for example, in school use a user may write certain notes or reminders (i.e. a reminder of a homework assignment) on the outer surface of a binder 60 which includes the writing surface 50. The writing 63 on the binder 60 is written in permanent ink and therefore resists smudging and accidental erasure, even when exposed to water and most common liquids. When the user desires to remove the marking 63 (i.e. when the homework project is complete or when a new homework assignment is received) the user can remove the markings 63 using the erasing tip 34 and absorbent portion 42 of the cap 40.

Rather than being part of a school product, the writing surface 50 may simply be a “stand-alone” board such that the writing surface 50 can operate as a bulletin board, and, for example, be coupled to a locker, wall, refrigerator or the like, or be loosely carrier. Thus the writing surface 50 may include magnets, patches of hook-and-loop fastening material (i.e. VELCRO®), hook or other fasteners located on a rear side thereof to aid in attaching the writing surface 50 to various other components. Further, the marker 10 (which may include the cap 40) may be packaged together with the writing surface 50 for sale such that the marker 10 and writing surface 50 are marketed and sold together.

Although the invention is shown and described with respect to certain embodiments, it is obvious that equivalents and modifications will occur to those skilled in the art upon reading and understanding the specification. The present invention includes all such equivalents and modifications and is limited only by the scope of the claims.

1. A system comprising a writing instrument including body having a marking portion and an eraser portion, wherein the marking portion is configured to dispense a permanent ink and said eraser portion is configured to dispense a solvent which solubilizes said permanent ink.

2. The system of claim 1 wherein said body is generally elongate, and wherein said marking portion is located at one end of said body and said eraser portion is located at a generally opposite end of said body.

3. The system of claim 1 wherein said body includes a first reservoir storing said permanent ink and a second reservoir storing said solvent.

4. The system of claim 3 further comprising an ink dispensing wick located at least partially in said first reservoir and extending generally outwardly from said body, and a solvent dispensing wick located at least partially in said second reservoir and extending generally outwardly from said body.

5. The system of claim 1 wherein said permanent ink is a solvent based permanent ink.

6. The system of claim 5 wherein said solvent based permanent ink is an alcohol based permanent ink.

7. The system of claim 1 wherein said permanent ink is an aqueous permanent ink.

8. The system of claim 1 wherein said permanent ink generally resists removal by soap and water.

9. The system of claim 1 wherein said solvent is an alcohol based solution.

10. The system of claim 1 further comprising at least one cap removably attachable to said body, said cap being shaped to generally seal at least one of said marking portion or said eraser portion when said cap is removably mounted to said body, wherein said cap includes an absorbent portion located thereon to absorb solvent dispensed by said eraser portion.

11. The system of claim 10 wherein said cap is shaped to generally seal either said marking portion or said eraser portion depending upon the location of said cap when said cap is removably mounted to said body.

12. The system of claim 1 further comprising a writing surface upon which said marking portion can be pressed such that said marking portion dispenses said permanent ink on said writing surface.

13. The system of claim 12 wherein said writing surface includes a polymeric material that is chemically resistent to said solvent.

14. The system of claim 13 wherein said writing surface is made of polypropylene or polyethylene.

15. The system of claim 12 wherein said writing surface is part of a binder, notebook, folder, divider, portfolio or book cover.

16. The system of claim 12 wherein said writing surface and said body are packaged together for sale.

17. A writing instrument comprising:
a generally elongate body having a marking portion located at one end of said body and an eraser portion located at a generally opposite end of said body, said marking portion being configured to dispense an alcohol based permanent ink which generally resists removal by soap and water, said eraser portion being configured to dispense a solvent which solubilizes said permanent ink; and
a cap removably attachable to said body, said cap being shaped to generally seal at least one of said marking portion or said eraser portion when said cap is removably mounted to said body, wherein said cap includes an absorbent portion located thereon to absorb any solvent dispensed by said eraser portion.

18. A method for marking and erasing ink comprising the steps of:
providing a writing surface;
providing a writing instrument having a body including a marking portion and an eraser portion, wherein said marking portion includes a permanent ink capable of marking on said writing surface and said eraser portion includes a solvent capable of solubilizing said permanent ink;
applying said marking portion to said writing surface such that said permanent ink is deposited on said writing surface; and
applying said erasing portion to said deposited permanent ink such that said solvent is deposited on and solubilizes said deposited permanent ink.

19. The method of claim 18 wherein said body is generally elongate, and wherein said marking portion is located at one end of said body and said eraser portion is located at a generally opposite end of said body.

20. The method of claim 18 wherein said body includes a first reservoir storing said permanent ink, a second reservoir storing said solvent, an ink dispensing wick located at least partially in said first reservoir and extending generally outwardly from said body, and a solvent dispensing wick located at least partially in said second reservoir and extending generally outwardly from said body.

21. The method of claim 18 wherein said permanent ink is an alcohol based permanent ink that generally resists removal by soap and water.

22. The method of claim 18 wherein said solvent is an alcohol based solution.

23. The method of claim 18 wherein said writing instrument includes at least one cap removably attachable to said body, said cap being shaped to generally seal at least one of said marking portion or said eraser portion when said cap is removably mounted to said body, wherein said cap includes an absorbent portion located thereon, and wherein the method further includes applying said absorbent portion to said solubized deposited ink and to said deposited solvent to absorb said solubized deposited ink and said deposited solvent.

24. The method of claim 18 wherein said writing surface is part of a binder, notebook, folder, divider, portfolio or book cover.
